(19) United States
(12) Patent Application Publication
(10) Pub. No.: US 2005/0225764 A1
(43) Pub. Date: Oct. 13, 2005

(54) Device and method for detecting fluorescence comprising a light emitting diode as excitation source

(76) Inventors: Tito Bacarese-Hamilton, Surrey (GB); Andrea Crisanti, London (GB); Uri Friedlander, London (GB); Tony Canas, New Malden (GB); John Attridge, Ripley (GB); Philip Vessey, East Horley (GB)

Correspondence Address: LAHIVE & COCKFIELD, LLP., 28 STATE STREET, BOSTON, MA, 02109, US

(21) Appl. No.: 10/512,030

(22) PCT Filed: Apr. 24, 2003
(86) PCT No.: PCT/GB03/01756

§ 371 Date: Jun. 21, 2005

(30) Foreign Application Priority Data
Apr. 24, 2002 (GB) 0209329.2

(51) Int. Cl. G01N 21/64

(52) U.S. Cl. 356/417; 250/458.1

(57) ABSTRACT

A device (100) for reading fluorescent signals comprising: an illuminator (110) for illuminating a material (130) bound with a fluorophore, at an appropriate wavelength to induce fluorescence; a detector (140) for detecting fluorescent signals emitted by the material (130); a signal processor for processing the signals detected; the device defining an optical system (170, 120, 240, 190, 180, 200, 150, 220, 210) having an excitation optical path and a detection optical path; characterised in that the illuminator (110) comprises a light emitting diode (LED), and in that the illumination illuminates all, or a substantial portion of the material (130) simultaneously.

This invention relates to a device for detecting fluorescence emitted from a material, and particularly, but not exclusively, to a device for detecting and reading fluorescent signals emitted from samples forming a microdot assay array.

A microarray assay comprises a plurality of microspots of immunoreagents (reagent spots) on a microscope slide. The spots are nominally 200 microns in diameter, and on a pitch of 600 microns.

The invention also relates to a device for detecting and reading fluorescent signals emitted from a single sample of material.

It is known to add a fluorophore to microspots to be analysed and then to use a detection and reading system to read fluorescence signals emitted from the microspots in order to analyse the samples. This technique is particularly useful when analysing samples of DNA, or for analysing antigens and/or antibodies in a sample. The tests are of the type known as immunoassay type tests.

In the course of running such microarray tests a fluorescently labelled conjugate becomes bound to a reagent spot in a concentration that can be related to an analyte concentration depending on the format of the test.

Fluorescence is one of the most important imaging modes in biological analysis. It involves the use of antibodies labelled with fluorophores to detect substances within a specimen. Immunofluorescence entails the conjugation of a primary antibody with a fluorophore, (such as a fluorescein or rhodamine). For indirect fluorescence a primary antibody is visualised by using a fluorophore conjugated secondary antibody raised against the immunoglobulins of the species in which the primary antibody was raised.

A specimen to be analysed must be labelled with a fluorescent probe. Fluorescent probes are available for a wide range of biological preparations allowing analysis of such things as macromolecular structures (such as proteins, lipids, carbohydrates and nucleic acids) and physiological ions (such as calcium and pH).

Before accepting the localisation of an antigen the specificity of the staining and the visualisation must be established. The physical characteristics, limitations and capability of a fluorescent probe must be established. The major considerations are the excitation/emission wavelengths of the fluorophore to be used, the wavelength of the illumination available and the optical filters used.

Several factors must be considered when selecting fluorescent probes. The major considerations are the excitation/emission wavelengths of the probe to be used, the wavelength of the illumination available and the filters used.

Major factors that influence fluorophore selection are the emission spectrum and quantum efficiency of fluorescence (Qf), the absorption spectrum and molecular extinction coefficient (E), and decomposition of the fluorophore due to photobleaching.

The difference between the excitation and emission maxima for any given fluorophore is referred to as a Stoke's shift.

A known reading system for reading fluorescence signals comprises a confocal imaging microscope arrangement using a laser light source. In such a system a laser beam of suitable wavelength (from a tuneable He Ne laser running at a few milliwatts power) is focussed to a small spot having a minimum diameter of about 5 microns on an assay slide surface that has been previously dried. Fluorescence is then detected using a photomultiplier detector (PMT) via a suitable optical filtration.

An image is constructed by scanning the slide in two dimensions under the laser spot. An image can be acquired in about one minute, but analysis by software is complicated in terms of the image analysis processes. These processes can be complex because of both the large amount of data generated and the analysis algorithms required to produce an unambiguous measurement of the integrated signal from each microspot.

An alternative reading system comprises forming an image of the slide onto a CCD array. In such a system the slide is either flood illuminated, or a laser spot is scanned across its surface to produce a signal for the CCD array to record.

A disadvantage with this known system is that the required signal to noise ratio means that the CCD may often need to be cooled significantly below ambient temperatures using Peltier heat pumps. Great care must be taken in the optical design to ensure uniform image quality and calibration across the detector array. This adds to costs and impacts on the commercial viability of the approach in a diagnostics application.

Each of these known systems generates relatively high resolution images of each spot in the array. However, to interpret the assay requires integration of the total fluorescence from each spot. The large volumes of data inherent in an image and the subsequent processing burden are a hindrance.

According to a first aspect of the present invention there is provided a device for reading fluorescent signals comprising:
an illuminator for illuminating a material bound with a fluorophore, at an appropriate wavelength to induce fluorescence;
a detector for detecting fluorescent signals emitted by the material;
a signal processor for processing the signals detected;
the device defining an optical system having an excitation optical path and a detection optical path;
characterised in that the illuminator comprises a light emitting diode that illuminates the material with incoherent illumination;
the material comprises a microarray assay comprising a plurality of microspots; the material is deposited on a substantially flat surface and the illuminator simultaneously illuminates all, or a substantial portion of one of the microspots.

A method of analysing signals emitted from a sample of material bound with a fluorophore, the method comprising the steps of:
illuminating the sample at an appropriate wavelength to cause fluorescence in the sample;
detecting fluorescent signals emitted by the sample once the sample has been illuminated;
analysing signals detected by the detector,
characterised in that the sample is illuminated with incoherent illumination using a light emitting diode (LED), the material comprises a microarray assay comprising a plurality of microspots; the material is deposited on a substantially flat surface and in that all, or a substantial portion of one of the microspots is illuminated simultaneously.

Existing systems for reading fluorescent signals particularly from microarray assays have all been imaging systems which produce high resolution image of the microarray, typically comprising over 400 pixels for subsequent analysis.

To achieve the signal to noise levels required to measure the signal from each pixel comprising the image, it had been thought necessary to use a coherent laser light source of relatively high power to illuminate the material but generally such lasers are expensive and excitation wavelengths available are limited. Focussing a coherent laser source produces a small illumination area on the sample, typically less than 5 microns in diameter. This means that to read 200 micron diameter microspots of a microdot assay array, it would be necessary for either the illumination spot or the sample slide to be scanned at high speed to obtain a complete image of the array within an acceptable time.

In a system using a laser to scan the assay array, it can be assumed that:

1. T is the time taken to read one whole assay spot (about 1 second):

2. D is the diameter of the assay spot (typically 200 microns);

3. d is the diameter of the laser focus (typically 5 to 50 microns);

4. P is the laser power (about 2 mW in green and yellow).

Then each pixel of the assay spot receives energy of only:

$$P \times T \times {( \frac{d}{D} )}^{2} Joules$$

This amounts to approximately 50 micro Joules assuming a pixel size of approximately 10 microns. The ratio of diameters (d/D²) sets the scanning efficiency which may range from 1/16 to 1/1600, and will usually be in the lower part of this range (i.e. smaller pixels). This is to avoid “mixels” in the image which are hard-to-interpret pixels which contain partly fluorescent signal and partly background.

The inventors have realised that it is possible to read the fluorescence by illuminating the microspot of material with a beam of light that illuminates the whole spot simultaneously. Since an image is not required with the present invention, the laser power which would be directed to one 5 micron diameter area in the array in the known examples as set out above, can now be spread over the entire spot for an entire one second reading time. This approach enables LEDs, which are low cost light sources, to be used as the illumination source. Each fluorescent molecule will receive the same optical energy as it would do if a coherent light source was used as the illumination source. However, the detector will yield a single reading requiring no further signal analysis (rather than a 400 pixel image per microspot).

In fact use of coherent light source in the present invention would, surprisingly, be a disadvantage, because of additional noise introduced in the signal arising from the interference effects.

The device according to the present invention, in collecting light from the whole microspot, produces significantly less data (i.e. one reading per microspot) than conventional systems. It therefore does not require sophisticated signal processing algorithms and thus does not impose a cost overhead on the electronics and computing requirements of the final system. In addition the mechanics of the system according to the present invention are simpler than known systems and therefore more reliable than the known systems.

The present invention therefore has great advantages over the imaging microscope and the greater complexity of the CCD approach for a microdot readout.

It had previously been thought not to be possible to use an LED as the illumination source, because although similar power outputs are available from LEDs as compared with an HeNe laser, for example, the LED is an extended (non coherent) source of radiation and is therefore more difficult to focus without loss.

Several different types of LED are available on the market, and it is also possible to design an LED having particular qualities.

Because LEDs of different wavelengths are known, an LED of appropriate wavelength may be chosen to complement the particular fluorophore being used in the analysis.

For example, the LED could comprise either a green or yellow LED associated with a hyperbolic front lens to obtain a narrow angular emission.

In use the device defines an optical system having an excitation path between the illuminator and the material to be analysed, and a detection optical path between the illuminated sample and the detector.

Light emitted from an LED is spectrally quite narrow, typically 70 nanometers for a yellow 594 nanometer LED. However, unlike the narrow band emission from a laser, LEDs have a significant tail that can extend out into the fluorescence emission band. The use of suitable optical filters blocks emission from the tail, and thus reduces non-specific crosstalk through to the detection system.

Advantageously therefore the device further comprises an excitation filter which serves to filter out longer wavelengths before they reach the material to be analysed.

Preferably, the excitation filter comprises a band pass interference filter in combination with a dichroic beam splitter.

In any fluorescence measurement the sensitivity is ultimately determined by the noise on the background signal when no fluorophore is present. The background signal usually arises from excitation light breaking through to the detector as a result of scatter or reflection from the sample or its container. It may be assumed that the noise is roughly proportional to the background signal and so the larger the background signal the higher the noise levels and the poorer the sensitivity.

The band pass interference filter is used generally to reduce background noise in fluorescent applications. This type of filter has very good blocking characteristics close to the pass band to minimise breakthrough. The dichroic beam splitter acts in conjunction with the short band pass interference filter to filter out longer wavelengths.

If the fluorophore chosen has a small Stoke's shift it becomes more difficult to provide good blocking between the excitation and emission filter pass bands and a higher background noise results.

Advantageously the device further comprises a detection filter to filter out any directly reflected illumination.

The material to be analysed is preferably deposited on a substantially flat surface, preferably a glass slide which represents a relatively clean surface. The surface of glass slide is substantially smooth at a microscopic scale and the bulk of the slide is optically uniform. These features ensure that light that is either transmitted through the glass slide, or reflected off its surface maintains it polarisation.

Advantageously, the device further comprises a first polarising filter in the excitation optical path and a second polarising filter in the detection optical path orientated at right angles to the first such that the two polarising filters comprise crossed polarisers. With this arrangement, it is possible significantly to reduce the amount of reflected excitation light reaching the detector. In practice, this means that the background noise signal may drop by a factor of 100 to close to zero.

The fluorescence signal is randomly polarised. It is believed that this random polarisation occurs because the molecules rotate during the typical 10 nanosecond fluorescent lifetime. The crossed polarisers thus reject about half of the fluorescence. However the net effect is a dramatic background reduction and improvement in dynamic range for a small signal loss. This effect is especially important for very weak assay spots.

Alternatively, the device comprises a polarising beam splitter which replaces the cross polarisers and the dichroic beam splitter and has the same effect as crossed polarisers.

The device may comprise two or more LEDs, and in such a device, there will be an excitation filter and a detection filter associated with each LED.

Preferably, the signal processor comprises a phase sensitive (lock-in) detector.

The invention will now be further described by way of example only with reference to the accompanying drawings in which:

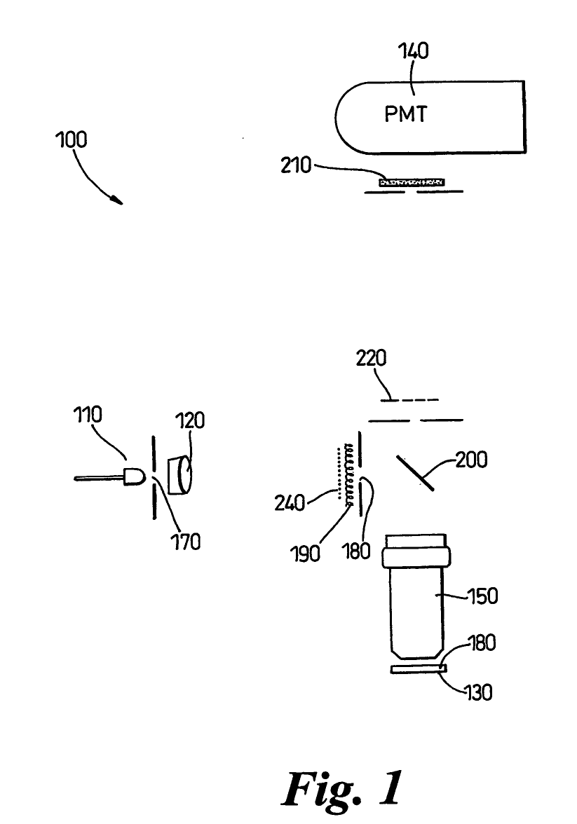

FIG. 1 is a schematic representation of a device according to the present invention in which the illuminator comprises a single LED;

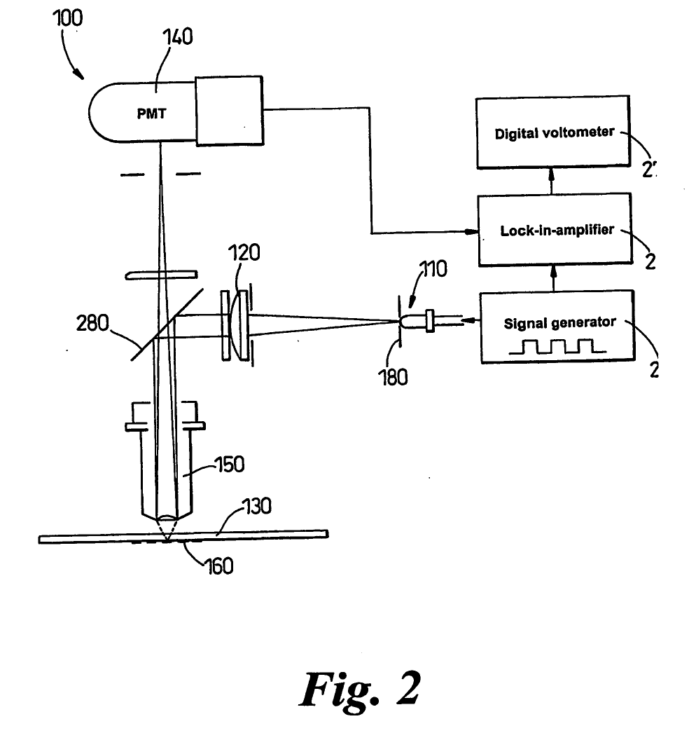

FIG. 2 is a schematic representation of the device shown in FIG. 1 in which the crossed polarisers have been replaced by a polarising beam splitter; and

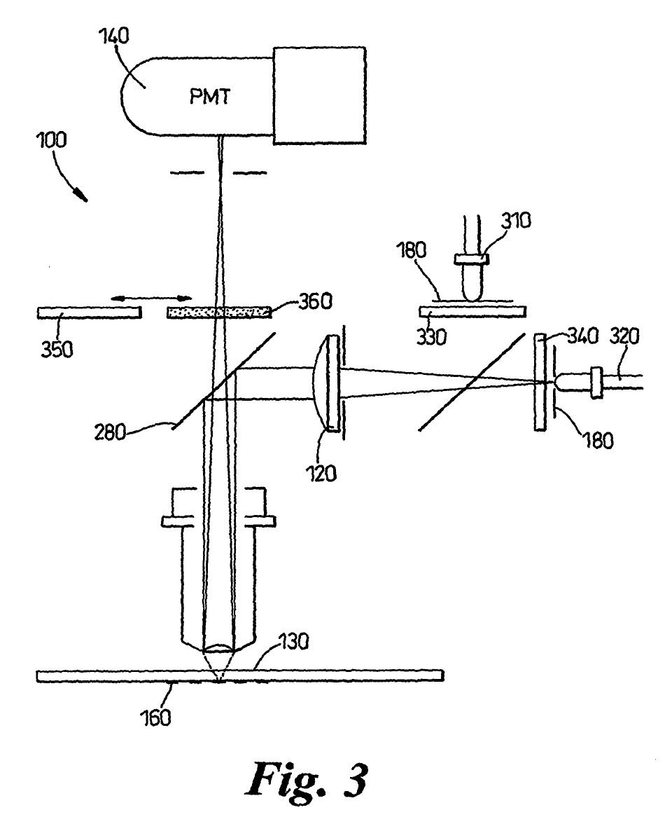

FIG. 3 is a schematic representation of a device according to the present invention in which the illuminator comprises two LEDs.

Referring to FIG. 1, a device for reading fluorescence signals from a material is designated generally by the reference numeral 100. The material to be analysed has been deposited on an assay slide 130 and may be in the form of an array of microdots, for example, or alternatively could be a single sample. The sample has been bound with a fluorophore suitable for analysing the particular sample.

The device comprises an illuminator 110 in the form of a light emitting diode (LED). The LED is associated with a hyperbolic lens (not shown) which reduces the angular emission of the LED.

In this example, the material to be analysed is in the form of microdots on an assay slide 130.

The device further comprises a detector for detecting the fluorescence signals emitted from the sample to be analysed once it has been illuminated in the form of a photo-multiplier tube (PMT) 140. The assay slide 130 is positioned in a plane containing the PMT aperture. The assay slide is also positioned under a microscopic lens 150, and microscope 150 is focused by placing an eye-piece to view the plane containing the aperture of the PMT 140. The longitudinal position of the slide 130 (or the whole optical system) is adjusted as appropriate so that the assay surface 160 appears in focus at the same time. If the eye-piece is used without a detector aperture a small illuminated disc is visible into which an assay spot should just fit. The detector is sized such that it fits the illuminated patch formed by the objective and aligned to be concentric with it.

Light from the LED 110 is used to illuminate the assay slide 130. A plane located a few millimetres in front of the “nose” of the LED has the most uniform characteristics, and the optical system 100 is arranged to image this plane onto the assay slide with appropriate demagnification. An aperture 170 placed in front of the LED limits the spatial extent of the source.

Positioned close to the aperture is a field lens 120 that forms an image of the LED roughly at the microscope objective. The field lens 120 fills the aperture of the objective to ensure maximum delivery using all available numerical apertures.

The objective then acts as a condenser in a classical Kohler arrangement and images the LED aperture onto the assay surface. A Kohler arrangement is one in which a converting lens is placed closest to the field stop and forms an image of a source in the focal plane of the condenser, which now contains the condenser diaphragm. The rays from each source point then emerge from the condenser as a parallel beam. This arrangement has the advantage that the irregularities in the brightness distribution on the source do not cause irregularities in the intensity of the field illumination.

The correct demagnification is obtained by adjusting the position of the LED aperture and the field lens. The aperture comprises a fixed diameter hole for convenience.

The LED 110 emits a significant amount of light in a “ring” at high angles as well as a central beam. The optical system 100 therefore further comprises an aperture 180 which is positioned downstream of the field lens 120 and acts together with aperture 170 to reduce stray light.

An excitation filter in the form of a short band pass interference filter 190 filters out the portion of the LED emission which extends out into the fluorescence emission band. Light from the LED then strikes a dichroic beam splitter 200 which together with the excitation filter 190 serves to filter out longer wavelengths before they reach the assay slide.

An emission band pass filter 210 is positioned above the PMT aperture to reject any directly reflected illumination. This position exposes the filter 210 to a minimum of stray light and places it in the most collimated section of the beam. Because it will be necessary to detect quite weak fluorescence reliably, the blocking performance of the emission filter 210 is critical to the operation of the device 100.

An analyser in the form of a polariser 220 is positioned in front of the emission filter 210 in order to remove unwanted background signals. The polariser 220 is orientated so that it is perpendicular to the input polarisation of the illumination. The polariser 220 works in conjunction with polariser 240 the two polarisers 220,240 together forming a pair of crossed polarisers. Since most of the unwanted light results from specular reflections, it preserves its original polarisation and is thus rejected by polariser 220. The fluorescent signal is randomly polarised, presumably because the molecules rotate during the ten nanoseconds fluorescence lifetime. The polariser 220 thus rejects about half the fluorescence (slightly more in practice due to absorption). The net effect is a dramatic background reduction and improvement in dynamic range for a small signal loss.

Referring now to FIG. 2, a further embodiment of the invention is shown. Parts of the device which are equivalent to parts of the device shown in FIG. 1 have been given corresponding reference numerals for reasons of clarity.

The device of FIG. 2 is very similar to that of FIG. 1. The emission filter 210 and the excitation filter 190 have both been slightly repositioned.

However, the crossed polarisers 220,240 have been replaced by a polarised beam splitter which combines the effects of the dichroic beam splitter 200 and the polarisers 220, 240 of FIG. 1.

The polarised beam splitter 280 has a multi-layer construction which provides it with a natural polarisation sensitivity. This introduces a loss into the system since the LED is an unpolarised source of light. However, it can be used to great advantage for filter leak suppression.

The LED 110 is fed from an oscillator (250) and emits pulses of light at a frequency of about 80 hertz. However any frequency up to about a few hundred hertz would be appropriate. The alternating component of the PMT is fed to a commercial phase sensitive detector (PSD) (260), the input sensitivity and time constant of which is variable. The output of the PSD is a steady voltage that can be read using a commercial volt meter (270).

Referring now to FIG. 3, a second embodiment of the invention in which two LEDs are used is shown. Again parts which correspond to those parts in FIGS. 1 and 2 have been given corresponding reference numerals for the sake of clarity.

The LEDs 310,320 emit light of different wavelengths to one another. Associated with each LED 310, 320 is a respective excitation filter 330,340. In addition, there is an emission filter 350,360 associated with each of the LEDs 310,320 respectively.

Depending on the material which is to be analysed and the fluorophore which has been chosen as appropriate for analysis of the material, one of the two LEDs 310,320 will be used to illuminate the sample on the assay slide 130. The appropriate emission filter 350,360 will be moved into position depending on which LED is being used.

The device comprises a polarising beam splitter 280 of the type used and described in the device shown in FIG. 2. This is particularly appropriate for a system using two or more LEDS since the polarising beam splitter replaces the dichroic beam splitter, and thus removes the necessity of replacing the dichroic beam splitter each time the LEDs are changed.

The signal produced from the device of FIG. 3 is analysed in the manner described with reference to FIG. 2.

1. A device for reading fluorescent signals comprising:
an illuminator for illuminating a material bound with a fluorophore, at an appropriate wavelength to induce fluorescence;
a detector for detecting fluorescent signals emitted by the material;
a signal processor for processing the signals detected;
the device defining an optical system having an excitation optical path and a detection optical path;
characterised in that the illuminator comprises a light emitting diode that illuminates the material with incoherent illumination;
the material comprises a microarray assay comprising a plurality of microspots; the material is deposited on a substantially flat surface and the illuminator simultaneously illuminates all, or a substantial portion of one of the microspots.

2. A device according to claim 1 further comprising an excitation filter positioned in the excitation optical path to filter out longer wavelengths emitted by the LED before they reach the material to be analysed.

3. A device according to claim 2 wherein the excitation filter comprises a short band pass interference filter.

4. A device according to claim 1 further comprising an emission filter positioned in the detection optical path to filter out any directly reflected illumination from the material.

5. A device according to claim 1 wherein the substantially flat surface comprises a glass slide.

6. A device according to claim 1 further comprising
a polarising filter positioned in the excitation optical path to be perpendicular to the input polarisation, and
a second polarising filter positioned in the detection optical path and orientated at right angles to the first polarising filter such that the two filters comprise crossed polarisers positioned in the excitation and the detection optical paths respectively.

7. A device according to claim 1 further comprising a polarising beam splitter positioned to lie in both the excitation and detection optical paths.

8. A device according to claim 1 wherein the signal processor comprises a phase sensitive detector.

9. A device substantially as hereinbefore described with reference to the accompanying drawings.

10. A method of analysing signals emitted from a sample of material bound with a fluorophore, the method comprising the steps of:
illuminating the sample at an appropriate wavelength to cause fluorescence in the sample;
detecting fluorescent signals emitted by the sample once the sample has been illuminated;
analysing signals detected by the detector,
characterised in that the sample is illuminated with incoherent illumination using a light emitting diode (LED), the material comprises a microarray assay comprising a plurality of microspots; the material is deposited on a substantially flat surface and in that all, or a substantial portion of one of the microspots is illuminated simultaneously.

11. A method of analysing signals emitted from a sample of material bound with a fluorophore using a device according to claim 1.

12. A method substantially as hereinbefore described with reference to the accompanying drawings.
